(19) United States
(12) Patent Application Publication
(10) Pub. No.: US 2014/0158590 A1
(43) Pub. Date: Jun. 12, 2014

(54) APPARATUS FOR A PARALLEL FLOW MANIFOLD SYSTEM FOR WATER FILTRATION

(71) Applicant: GENERAL ELECTRIC COMPANY, Schenectady, NY (US)

(72) Inventor: Timothy Scott Shaffer, Louisville, KY (US)

(73) Assignee: GENERAL ELECTRIC COMPANY, Schenectady, NY (US)

(21) Appl. No.: 13/707,631

(22) Filed: Dec. 7, 2012

(51) Int. Cl. C02F 1/00

(52) U.S. Cl. CPC C02F 1/00
USPC 210/136; 137/861

(57) ABSTRACT

An apparatus includes multiple manifolds, an inlet connecting line fluidly coupled to a flow inlet channel defined within a first manifold to a flow inlet channel defined within a second manifold, and an outlet connecting line fluidly coupled to a flow outlet channel defined within the first manifold and to a flow outlet channel defined within the second manifold. Another apparatus includes a plenum coupled to a surface of a multiple manifold apparatus including a influent channel fluidly coupled to a flow inlet channel defined within a first manifold and to a flow inlet channel defined within a second manifold, wherein the plenum also includes a secondary flow channel fluidly coupled to a flow outlet channel defined within the first manifold and to a flow outlet channel defined within the second manifold.

### BACKGROUND

The subject matter disclosed herein relates generally to water filtration, and more particularly to water filter manifold components and the like.

Water filters are used to extract contaminants such as chlorine, chloramine, volatile organic compounds (VOCs), lead, microbes and other undesirable substances. The presence of some such contaminants is a direct result of agricultural chemicals, industrial and municipal wastewater facility processes, water treatment and disinfection byproducts, urban runoff and/or naturally occurring sources in ground water supplies. Others contaminants are introduced after treatment processes within the home and/or municipal sources, for example, from piping and contact with contaminant items.

Household filters can generally be broken into two classes: Point of Entry (POE) filters and Point of Use (POU) filters. POE filters are placed at the entry point of water into the home and continuously filter all water that enters the home. POU filters are installed in areas such as kitchen sinks and refrigerators where water may be used for direct consumption.

A water filter system includes inlet/outlet tubing, a manifold and a filter component. The manifold receives untreated water, directs the water into a filter media, which subsequently directs the treated/filtered water back out for use. The filter media can vary depending on the contaminants targeted for removal. Sediment filters will take out fairly coarse particulate matter greater than 10 microns. Carbon filters, which generally include 60-70% carbon, 2-5% scavenger additives such as titantium dioxide, and 25-40% polyethylene binder dust, will extract contaminants such as chlorine, lead, VOCs, pharmaceuticals, particulates larger than 0.5 microns, and some large microbes such as cysts. The scavenger additives are included to shore-up the block's ability to remove those contaminants that carbon does not have an affinity to adsorb such as heavy metals like lead. Hollow fiber technology, ozone, ultraviolet (UV) lamps and quaternary technologies are also used to extract or destroy microbes, which can be as small as 0.015 microns. In virtually all cases, the filter media will be exhausted over time and use and need to be replaced in order to restore the system's ability to remove contaminants.

The filter media can be housed and attached to the manifold in two common manners. One approach is to have a removable media component that can be pulled from a pressure shell that encompasses the media when fastened to the manifold. Such an approach requires that water supply into the manifold be secured to avoid water loss and heavy spray during the removal of the pressure shell. An alternative approach is to fully encapsulate the filter media with a pressure vessel. In such an approach, the manifold will include a check valve within its incoming flow path. When the pressure vessel (that is, canister) is fully installed into the manifold, the check valve will be dislodged from closed position to a position that allows flow to bypass the check valve.

Currently, encapsulated systems are provided as single filter systems or as dual filter systems, where two canisters are placed in series. While the single systems will typically be rated to flow 0.85 gallons per minute (gpm) and claim 150 gallons of contaminant extraction, the dual (in-series) systems are rated at lower flow rates (0.65 gpm), but higher extraction levels (270 gallons). Such systems use the same basic manifold concept with the outlet treated flow from the first stage going directly to the inlet of the second stage. Also, the check valve system is the same for both stages. While the larger extraction levels are desirable, the loss of flow rate is not desirable.

Accordingly, there is a need to develop a multiple stage filter system that increases rated flow rates, while also raising the rated extraction claims above that of a single system. Also, there is a need to maintain the quick change, essentially drip-less capability currently available with encapsulated water filter systems.

### BRIEF DESCRIPTION OF EXAMPLE EMBODIMENTS OF THE INVENTION

As described herein, the exemplary embodiments of the present invention overcome one or more disadvantages known in the art.

A first aspect of the present invention relates to an apparatus comprising two or more manifolds, wherein at least a first manifold comprises a flow inlet channel defined in the manifold from a manifold inlet port to an inlet check valve, and from the manifold inlet port to an inlet connecting line, and a flow outlet channel defined in the manifold from an outlet check valve to an outlet connecting line; wherein at least a second manifold comprises a flow inlet channel defined in the manifold from the inlet connecting line to an inlet check valve, and a flow outlet channel defined in the manifold from an outlet check valve to a manifold outlet port, and from the outlet connecting line to the manifold outlet port; wherein the inlet connecting line is fluidly coupled to the flow inlet channel defined in the first manifold and to the flow inlet channel defined in the second manifold, and the outlet connecting line is fluidly coupled to the flow outlet channel defined in the first manifold and to the flow outlet channel defined in the second manifold.

A second aspect relates to a fluid filtration system comprising an apparatus as detailed in the first aspect above, and additionally comprising a filter cartridge having a filter media structure assembly and at least one channel for directing a flow of fluid.

A third aspect of the invention relates to an apparatus comprising two or more manifolds, wherein at least a first manifold comprises a flow inlet channel defined in the manifold from a manifold inlet port to an inlet check valve, and from the manifold inlet port to an influent channel defined in a dual flow plenum, and a flow outlet channel defined in the manifold from an outlet check valve to a secondary flow channel defined in the dual flow plenum; wherein at least a second manifold comprises a flow inlet channel defined in the manifold from the influent channel to an inlet check valve, and a flow outlet channel defined in the manifold from an outlet check valve to a manifold outlet port, and from the secondary flow channel to the manifold outlet port; wherein the influent channel is fluidly coupled to the flow inlet channel defined in the first manifold and to the flow inlet channel defined in the second manifold, and the secondary flow channel is fluidly coupled to the flow outlet channel defined in the first manifold and to the flow outlet channel defined in the second manifold.

Further, a fourth aspect relates a fluid filtration system comprising an apparatus as detailed in the third aspect above, and additionally comprising a filter cartridge having a filter media structure assembly and at least one channel for directing a flow of fluid.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates components of a water filter apparatus with a single manifold;

FIG. 2 illustrates components of a filter canister, in accordance with a non-limiting example embodiment of the invention;

FIG. 3 illustrates a cross-section view of a water filter apparatus with a single manifold;

FIG. 4 illustrates a side view image of a bayonet, in accordance with a non-limiting example embodiment of the invention;

FIG. 5 illustrates exploded and cross-section views of the filter canister cap and insert component, in accordance with a non-limiting example embodiment of the invention;

FIG. 6 illustrates a dual manifold parallel flow system, in accordance with a non-limiting example embodiment of the invention;

FIG. 7 illustrates an exploded view of a dual manifold parallel flow system, in accordance with a non-limiting example embodiment of the invention;

FIG. 8 illustrates a flow network in a parallel flow manifold system, in accordance with a non-limiting example embodiment of the invention;

FIG. 9 illustrates cross-section views of a parallel flow manifold system, in accordance with a non-limiting example embodiment of the invention;

FIG. 10 illustrates a dual manifold parallel flow system with a plenum attachment, in accordance with a non-limiting example embodiment of the invention;

FIG. 11 illustrates an exploded view of a dual manifold parallel flow system with a plenum attachment, in accordance with a non-limiting example embodiment of the invention;

FIG. 12 illustrates a flow network in a parallel flow manifold system with a plenum attachment, in accordance with a non-limiting example embodiment of the invention; and

FIG. 13 illustrates cross-section views of a parallel flow manifold system with a plenum attachment, in accordance with a non-limiting example embodiment of the invention.

### DETAILED DESCRIPTION OF EXAMPLE EMBODIMENTS OF THE INVENTION

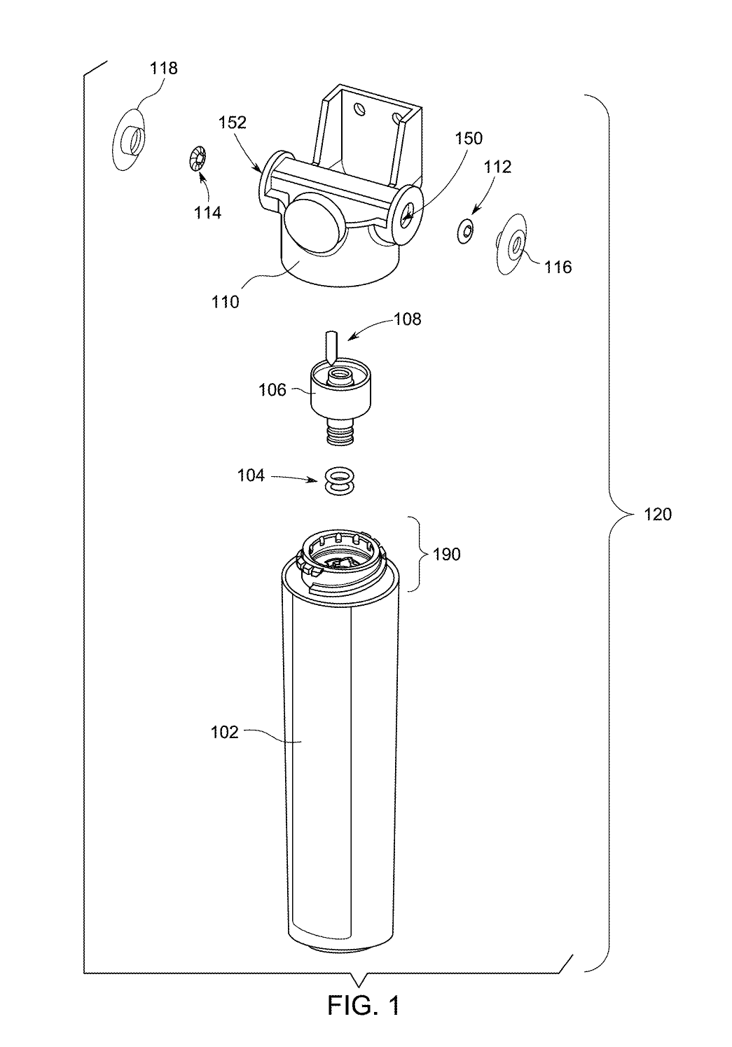

As described herein, one or more embodiments of the invention include techniques and apparatuses for a parallel flow manifold system for water filtration. For purposes of illustration, FIG. 1 through FIG. 3 depicts components in the context of an example water filtration system that includes a single manifold. The components of these figures will be used throughout the specification for descriptive purposes, while subsequent figures and corresponding description will detail aspects of the invention that include water filtration systems incorporating multiple manifolds and a parallel flow manifold system.

Accordingly, FIG. 1 presents components of water filter apparatus 120. By way of illustration, FIG. 1 depicts a filter canister 102, o-rings 104, a bayonet 106, a check valve 108, a manifold body 110, o-ring 112 and o-ring 114, and speed-fit cap 116 and speed-fit cap 118. As shown in FIG. 1, the filter canister 102 additionally includes an annular canister interlocking member 190. Additionally, the manifold body 110 includes a manifold inlet port 152 and manifold outlet port 150. These components are discussed in further detail herein.

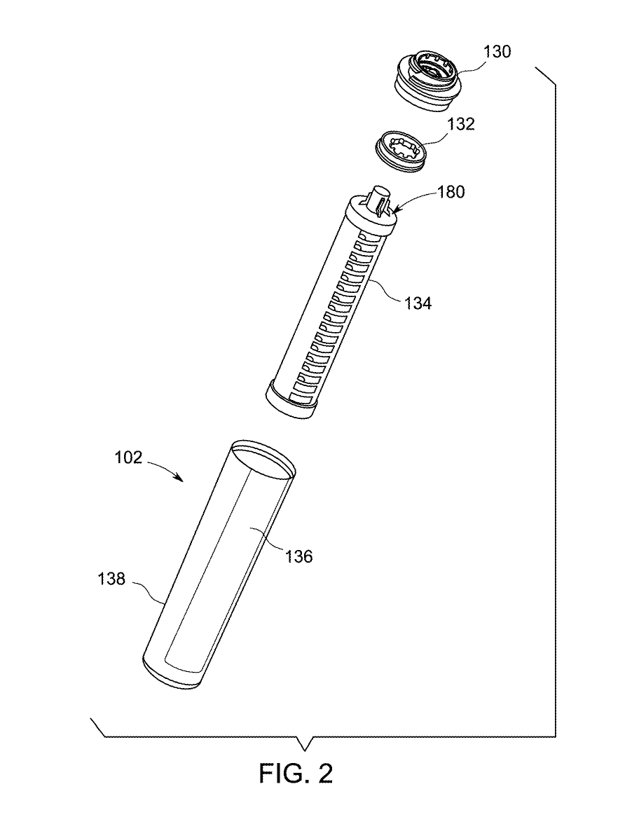

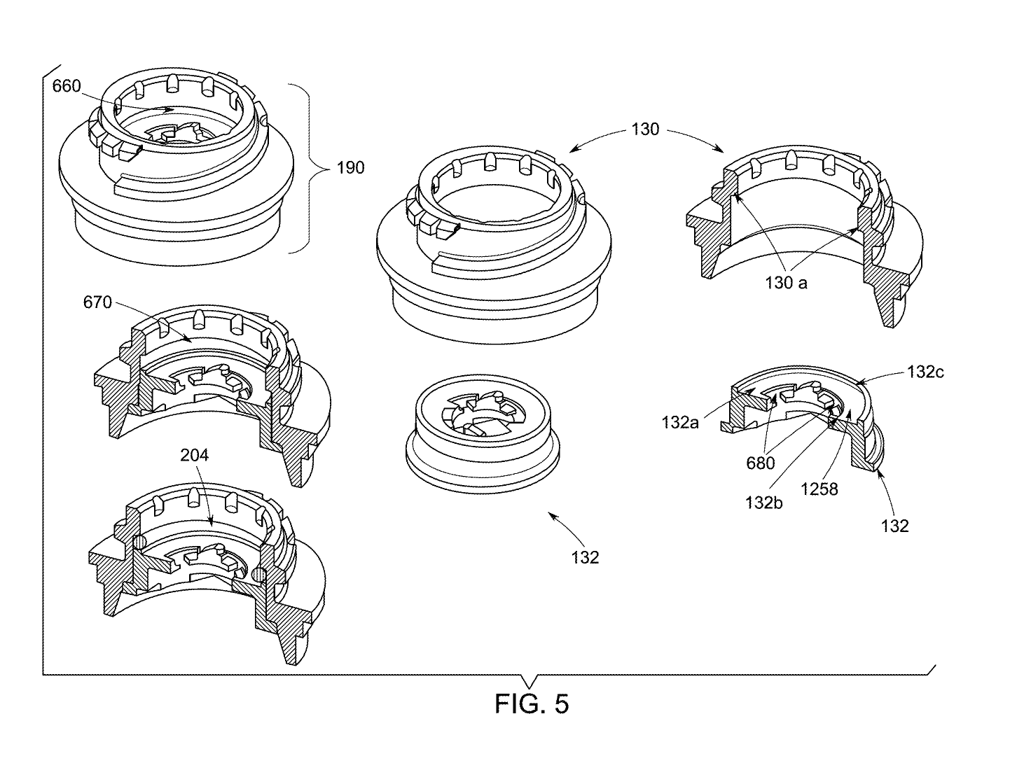

FIG. 2 illustrates components of the filter canister 102, in accordance with a non-limiting exemplary embodiment of the invention. By way of illustration, FIG. 2 depicts a filter cap 130 and an insert component 132, which comprise the annular canister interlocking member 190. In at least one embodiment of the invention, the annular canister interlocking member 190 can include a compression seal (such as, for example, in the form of an o-ring 204 as depicted in FIG. 5) positioned on the inner surface of the member 190. Additionally, in at least one embodiment of the invention, the insert component 132 enables various methods of engaging the check valve 108. The engagement amount of the check valve 108 can vary from, for example, 0.050 inches to 0.1875 inches depending on how far the check valve is to be pushed up. In an example embodiment, a 1/16″ diameter o-ring can be pushed around the check valve 108 up almost 1/16″ to break seal. Additional embodiments can include pushing higher (0 to 0.125″) to facilitate higher flow rates if desired or needed. Accordingly, in at least one embodiment of the invention, the check valve 108 engages the insert component 132 upon rotation of the filter canister 102 upon an approximately quarter turn of the filter canister 102, opening a passage-way through which fluid can pass.

FIG. 2 also depicts a media adapter cap 180 and a filter media structure assembly 134. As known in the art, the filter media structure assembly 134 can include one of multiple compositions. For example, the structure assembly can include carbon, a reverse osmosis membrane, an ultra-filtration component (such as a hollow fiber cartridge), etc. Additionally, as depicted in FIG. 2, the filter canister 102 can include a polypropylene canister portion 136 and a soft touch santoprene canister portion 138.

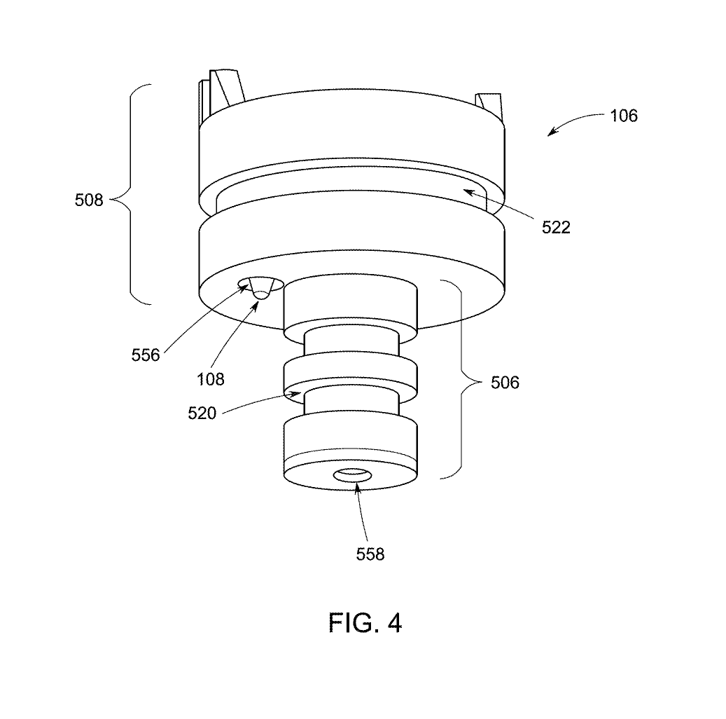

Also, at least one embodiment of the invention includes attaching a cartridge to a water filter head assembly, such as, for example, via adding an elastomeric seal component (such as, for example, o-ring 204 as depicted in FIG. 5) to the mating surface provided by the inner periphery of the annular canister interlocking member 190 to sealingly engage the external cylindrical surface of the inlet boss portion (depicted as component 508 in FIG. 4) of the bayonet 106 as the filter canister 102 is installed.

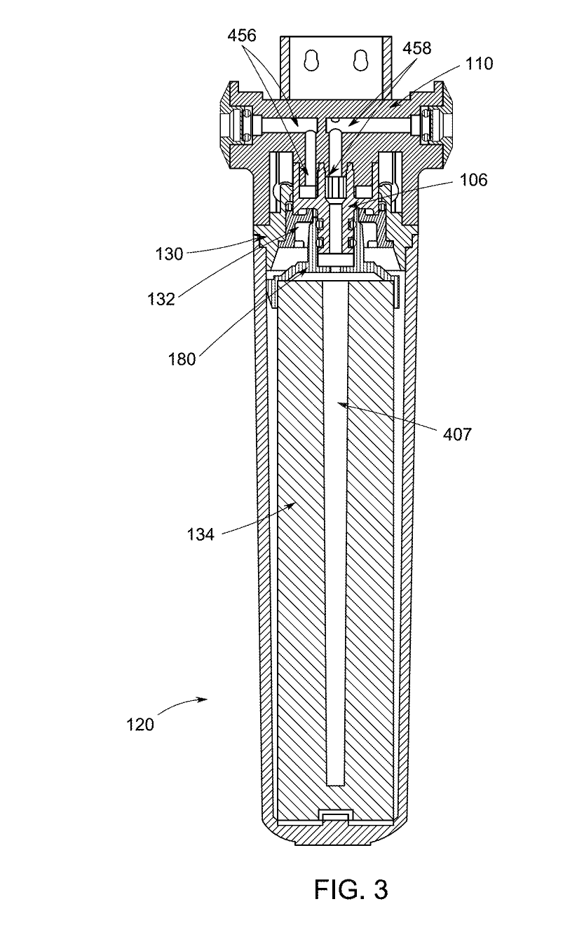

FIG. 3 illustrates a cross-section view of water filter apparatus 120, in accordance with a non-limiting exemplary embodiment of the invention. Specifically, FIG. 3 shows manifold body 110, bayonet 106, a flow inlet channel 456 defined within the manifold body 110 leading to the check valve 108, and a flow outlet channel 458 defined in the manifold body 110. The manifold inlet port 152 is operably fluidly coupled to a fluid source for receiving a flow of unfiltered fluid, and is also fluidly coupled to the flow inlet channel 456. The manifold outlet port 150 is fluidly coupled to flow outlet channel 458.

FIG. 3 also shows filter canister cap 130, insert component 132, media adapter cap 180, and the filter media structure assembly 134. As is known in the art, there are commonly two different filter media structure assembly types—carbon blocks and hollow fiber. The hollow fiber includes a plastic outer shell that contains the hollow fiber into a bundle. This bundle is potted in the shell such that water passes from outside the fibers into the center of individual fibers, where it flows through the fiber to a common outlet atop the cartridge. The insert component 132 (or in one or more embodiments, the filter canister cap 130) includes a centrally located hole or channel on the horizontal surface that acts to locate the filter media structure assembly 134 radially within the filter canister 102 and direct fluid thereto. The upwardly extending cylindrical portion of the cap 180 fits into the centrally located hole in insert component 132 to locate the media. Further, the media adapter cap 180 can be a portion of the filter media structure assembly 134 or coupled to the filter media structure assembly 134 as a separate component.

As noted above, new filters are being engineered to extract more contaminants at higher flow rates due to changes in both the media and filter geometry. By way of example, cartridges filled with hollow fiber media can be capable of removing bacterial and viral microorganisms down to a 15 nanometer size. Another media, as mentioned, includes a traditional carbon block, where the surface area has been increased by almost 50% but volume correspondingly only by approximately 20%.

Additionally, FIG. 4 illustrates a side view image of bayonet 106. As described herein, bayonet 106 is a protrusion that comes down off of the bottom of the manifold body 110 for sealing engagement with the filter canister 102. As noted, the bayonet 106 can, by way of example, be welded via ultrasonic, spin, or heat-stake means into the manifold body 110, thereby establishing a water flow path. The smaller diameter portion, also referred to herein as an outlet boss 506 of the bayonet 106, which includes annular spaces 520 for fitting o-rings 104 if desired, fits into the hollow cylindrical interior 182 of media adapter cap 180 in the middle of filter canister 102 to form a seal therebetween. By way of illustration, FIG. 3 depicts a double o-ring seal engaging the media adapter cap 180 of the filter media, wherein the o-rings (such as depicted as components 104 in FIG. 1) squeeze into the media adapter cap 180 to form a seal.

The fluid exiting the filter travels up through the flow outlet channel 458 (as depicted in FIG. 3) in the middle of the bayonet 106 and is ultimately directed out of the manifold body 110. The seal between outlet boss 506 and the filter canister 102 prevents the water exiting the filter canister 102 from leaking around outlet boss 506. The larger diameter portion, also referred to herein as an inlet projection or inlet boss 508 of the bayonet 106, provides a surface for sealingly engaging the filter canister 102 and more particularly for sealingly engaging a mating surface provided in this embodiment by an interior annular surface 660 of interlocking member 190, which is formed by the inner surface of the side wall of cap 130 together with the outer rim 132c of insert component 132, as hereinafter more fully described in reference to FIG. 5, to prevent the unfiltered fluid entering the filter canister 102 through the check valve 108 from leaking to the ambient environment outside of the manifold body 110.

As described and depicted herein, bayonet 106 includes the flow inlet channel 456 (as depicted in FIG. 3) around check valve 108 having a discharge opening 556 for discharging the fluid conveyed therein to the filter canister 102. The discharge opening 556 is defined in a lower margin of depending inlet boss 508. The inlet boss 508 has a circular cross section defined about a longitudinal axis and a circumferential outer margin. The discharge opening 556 is radially displaced from the longitudinal axis. Boss sealing means can include o-rings positioned in annular space 522 to seal the space between the inlet boss 508 and the inner periphery of the filter canister cap 130 when fully assembled. Additionally, an outlet opening 558 is fluidly coupled to the flow outlet channel 458. Further, the flow outlet channel 458 fluidly couples the outlet opening 558 to the manifold outlet port 150.

Accordingly, the bayonet 106 receives fluid flow from the manifold inlet port 152 in the manifold body 110. The bayonet 106 distributes the flow into the inlet boss 508 to the discharge opening 556 defined in the lower margin of the bayonet 106. Further, as is known in the art, structural support features above the discharge opening 556 can be provided to align and guide the movement of the check valve 108 along the longitudinal axis of the discharge opening 556.

As noted above, when engaged with the filter canister 102, the large diameter cylinder or inlet boss 508 provides a sealing surface for engagement with a first mating surface provided by an interior annular surface 660 of interlocking member 190, which is formed by the inner surface of the side wall of cap 130 together with the upwardly extending rim 132c of insert component 132, to provide a seal between the incoming, unfiltered fluid and ambient environment. The smaller diameter cylinder or outlet boss 506, when engaged with the filter canister 102, fits and forms a seal against cylindrical interior 182 of media adapter cap 180 and directs filtered fluid toward the exit of the manifold body 110. Each of these bayonet cylinders may, merely by way of example, include an o-ring or a set of o-rings as well as a set of glands to facilitate a proper seal.

On the bottom horizontal surface of the inlet boss 508, a plunger of the check valve 108 protrudes downward and is biased into this position via a mechanical spring within the check valve 108. This plunger is depressed upward as it engages a complementary surface on the filter canister 102 when the filter canister 102 is being installed in the manifold body 110, which surface may comprise recessed sumps or raised protrusions, depending on orientation of the check valve, as is known in the art.

FIG. 5 illustrates exploded and cross-section views of the filter canister cap 130 and insert component 132. Additionally, FIG. 5 depicts the annular canister interlocking member 190, including the interior annular surface 660 of interlocking member 190, which comprises a first mating surface as detailed herein. Further, FIG. 5 depicts an o-ring groove 670 for receiving and retaining o-ring 204. The groove 670 is formed, in the embodiment illustrated in FIG. 5, in the first mating surface formed by the upper edge of rim 132c on the insert component 132 and the inner bottom annular surface 130a on the filter canister cap 130 proximate the intersection of cap 130 and insert component 132. Additionally, the insert component 132, in at least one embodiment of the invention, is spun welded into the filter canister cap 130. In an example embodiment, the o-ring 204 sealingly engages the vertical walls of the inlet boss 508 of the bayonet 106 during installation in lieu of and/or conjunction with an existing o-ring installed on the outlet boss 506 of the bayonet 106. Specifically, as detailed herein, boss sealing means of the bayonet 106 include o-rings 104 positioned in annular spaces 520 to seal the space between the outlet boss 506 and the second mating surface, provided in the embodiments herein described by the inner periphery of the filter canister cap 130, when fully assembled.

FIG. 5 also depicts an annular recess 1258 formed by the upper facing surface 132a of the insert component 132, extending between inner upwardly extending rim 132b and outer upwardly extended rim 132c, as well as slot features 680 located around the inner hole of the insert component 132. In at least one embodiment of the invention, fluid entering via discharge opening 556 in inlet boss 508 travels into the inlet recess 1258 between the bayonet 106 and the surface 132a of the insert component 132 into the interior space between the filter canister cap 130 and the exterior surface of the media adapter cap 180, through the slot features 680 located around the central hole in the insert component 132. From this region the water flows into the space between the filter media and the cylindrical wall of canister 102 and then radially inwardly through filter media structure assembly 134 to the central bore media structure 407 of the assembly 134 and exits the canister through the central opening in cap 180 to outlet channel 458 of manifold 110 which passes through outlet boss 506.

In addition and/or conjunction with the example water filter system components above, at least one embodiment of the invention includes a point of use, encapsulated water filtration system that permits additional flow capacity by installing additional filter canisters to the manifold chassis.

When two filters canisters 102 are placed in series, ignoring other losses in the system, the flow rate will roughly drop by 50% or half. Additionally, for instance, filter suppliers often make a different filter canister for in-series systems with a larger outlet hole to reduce the resistance of the filter and assist with flow rates. This has a practical limitation, as, at some point, the outlet hole is not the flow limiting parameter and the filter media becomes the limiting factor. Accordingly, a parallel flow arrangement, such as described in connection with at least one embodiment of the invention, will produce a flow rate that is approximately double relative to an in-series arrangement, and will produce a level of filtration that is equal to or better than that of an in-series configuration. That is, as described herein, in a parallel flow arrangement, an inlet stream of pre-filtered fluid will be partitioned and each portion of pre-filtered fluid processed separately by one of the two or more filter canisters of the system approximately simultaneously, as opposed to an in-series arrangement which processes all of the inlet stream fluid through each of the multiple filter canisters one at a time.

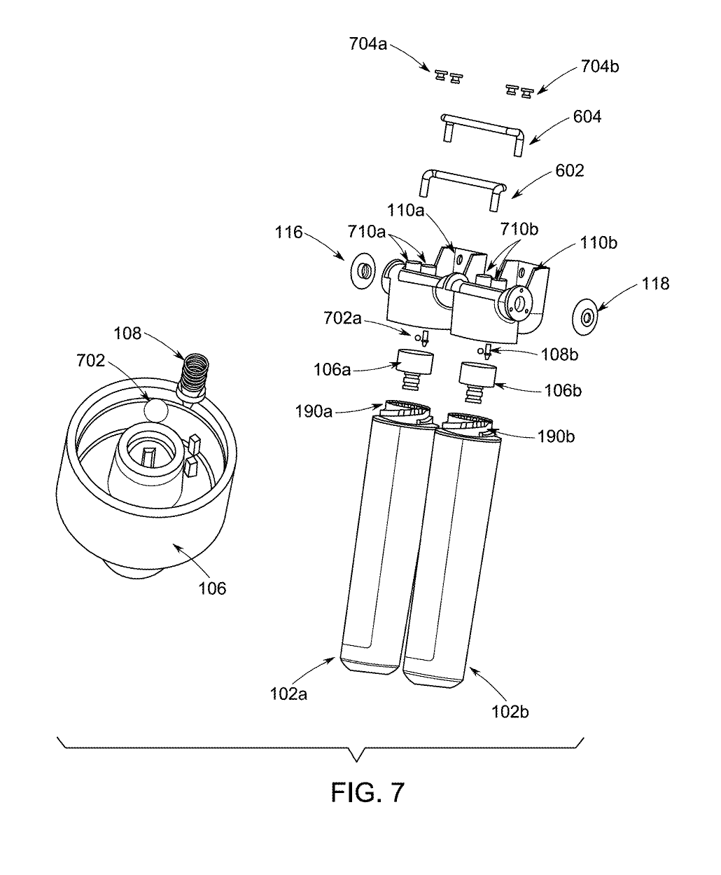

As also detailed herein, at least one embodiment of the invention includes a spherical elastomeric ball (such as component 702 in FIG. 7) added to the outlet side within the manifold assembly 110 that is pushed up when flow is present, but settles into a shut-off position when flow is stopped or the canister 102 is removed.

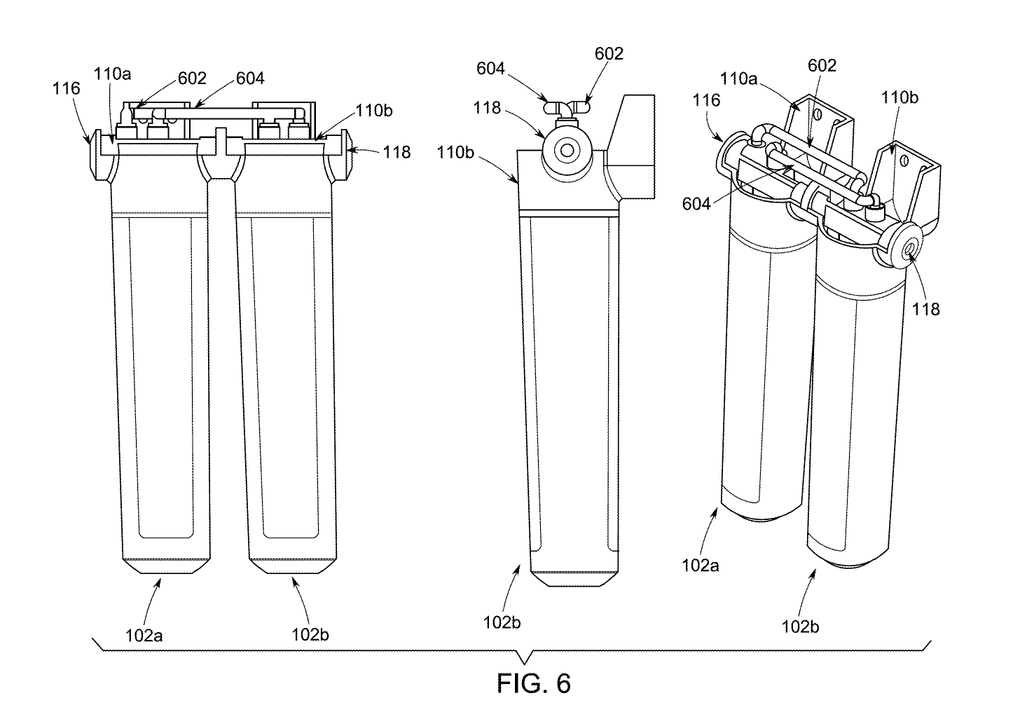

FIG. 6 illustrates a dual manifold parallel flow system, in accordance with a non-limiting example embodiment of the invention. While FIG. 6 shows two manifolds 110a and 110b, at least one embodiment of the invention can include more than two manifolds incorporated into a parallel flow system. By way of illustration, FIG. 6 depicts filter canisters 102a and 102b, manifolds 110a and 110b, speed-fit caps 118 and 116, and connecting tubular lines 602 and 604.

The connecting tubular lines 602 and 604 can be composed, for example, of standard polypropylene material and of a standard ¼ inch size. Additionally, in at least one embodiment of the invention, connecting tubular lines 602 and 604 can be fit into separate speed-fit connections (described further in FIG. 7). Also, while not illustrated in FIG. 6, at least one embodiment of the invention can further include a cover (for example, a snap-on piece) added over or on top of the manifolds 110a and 110b.

FIG. 7 illustrates an exploded view of a dual manifold parallel flow system, in accordance with a non-limiting example embodiment of the invention. By way of illustration, FIG. 7 depicts filter canisters 102a and 102b, annular canister/cartridge interlocking members 190a and 190b and bayonets 106a and 106b. As detailed herein (and illustrated in the close-up view of bayonet 106 in FIG. 7), in at least one embodiment of the invention, each bayonet 106 includes an inlet check valve 108 and an outlet check valve 702. The outlet check valve 702 can include an elastomeric ball valve that can be pushed up by a flow of fluid up towards the outlet port 150 so that fluid flows around the ball 702. However, when fluid attempts to flow in the opposite direction (that is, toward the canister 102), the ball 702 is pushed down into its recess to preclude the flow of fluid from moving in that direction.

FIG. 7 also depicts manifolds 110a and 110b, speed-fit caps 118 and 116, inlet connecting tube/line 602 and outlet connecting tube/line 604. Additionally, FIG. 7 depicts grommet fittings 704a and 704b, which are positioned in holes 710a and 710b on manifolds 110a and 110b, respectively. Accordingly, inlet connecting tube/line 602 and outlet connecting tube/line 604 are positioned into grommet fittings 704a and 704b.

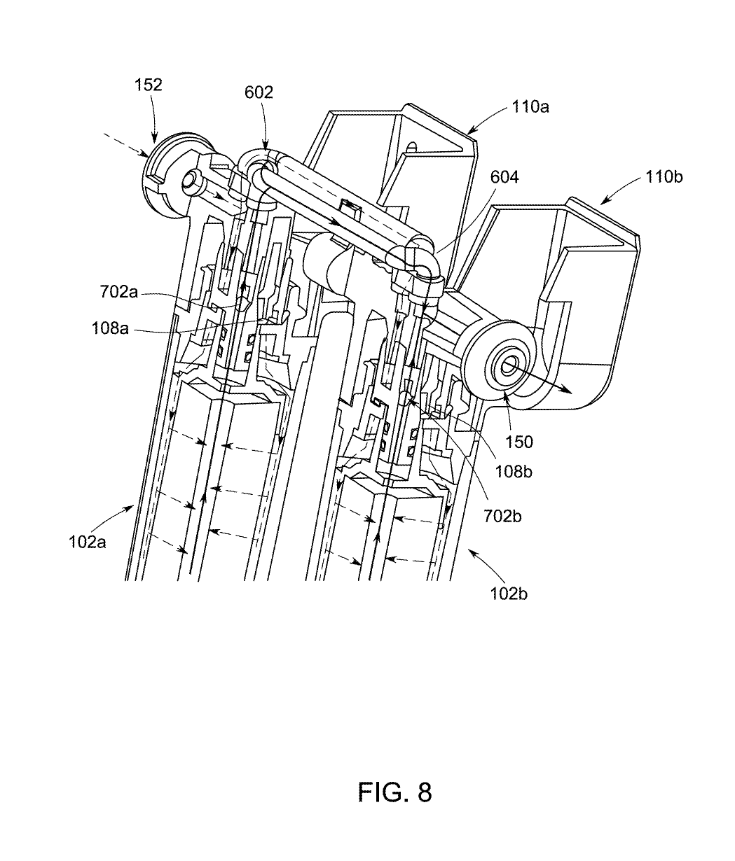

FIG. 8 illustrates a flow network in a parallel flow manifold system, in accordance with a non-limiting example embodiment of the invention. By way of illustration, FIG. 8 depicts filter canisters 102a and 102b and manifolds 110a and 110b. Specifically, a pre-filtered inlet stream of fluid (represented by the dashed line) enters manifold inlet port 152 and travels into and through the inlet connecting tube/line 602 as well as into canister 102a through the inlet check valve 108a and through the filtration media. The portion of the pre-filtered inlet stream that traveled through the inlet connecting line 602 continues into canister 102b through the inlet check valve 108b and through the filtration media.

As additionally illustrated in FIG. 8, after the pre-filtered inlet stream flows through the filtration media, the filtered outlet stream (represented by the bold solid line) travels through outlet check valves 702a and 702b, respectively, and continues into and through outlet connecting tube/line 604 to ultimately exit through manifold outlet port 150.

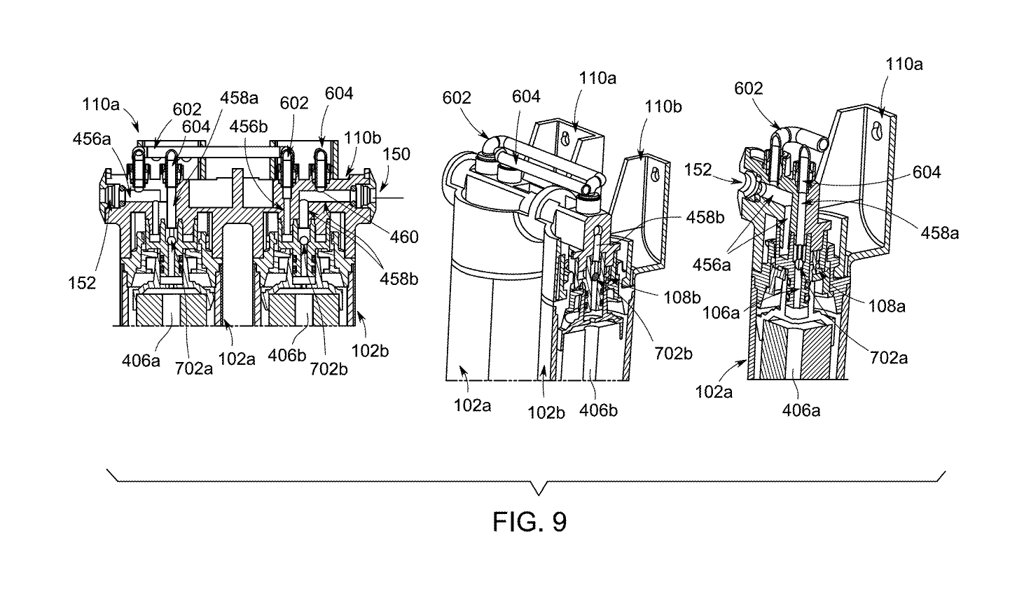

FIG. 9 illustrates cross-section views of a parallel flow manifold system, in accordance with a non-limiting example embodiment of the invention (specifically, the same embodiment as depicted in FIG. 8). By way of illustration, FIG. 9 depicts filter canisters 102a and 102b and manifolds 110a and 110b. Specifically, the cross-section views of FIG. 9 show a pre-filtered inlet stream of fluid (more specifically, a portion thereof) entering manifold inlet port 152 and traveling into flow inlet channel 456a, a portion of the fluid moving up into/through the inlet connecting tube/line 602 and a portion of the fluid moving into canister 102a around the inlet check valve 108a and into the filtration media via flow inlet channel 456a. The portions of fluid move into the separate components as a result of known principles such as the path of least resistance. After the portion of the pre-filtered inlet stream flows through the filtration media, a filtered outlet stream travels around outlet check valve 702a (which is positioned in bayonet 106a), and continues into/through flow outlet channel 458a and into and through outlet connecting tube/line 604 to ultimately exit through manifold outlet port 150 via flow outlet channel 458b.

As similarly illustrated in FIG. 8, the portion of the pre-filtered inlet stream that traveled from inlet port 152 through the inlet connecting line 602 continues into flow inlet channel 456b of canister 102b, around the inlet check valve 108b and through the filtration media. After this portion of the pre-filtered inlet stream flows through the filtration media, a filtered outlet stream travels around outlet check valve 702b (which is positioned in bayonet 106b (not numbered in FIG. 9)), and continues into/through flow outlet channel 458b, ultimately exiting through manifold outlet port 150. The filtered outlet stream from canister 102a merges with the filtered outlet stream of canister 102b in flow outlet channel 458b at merge point 460, and the merged stream exits through manifold outlet port 150.

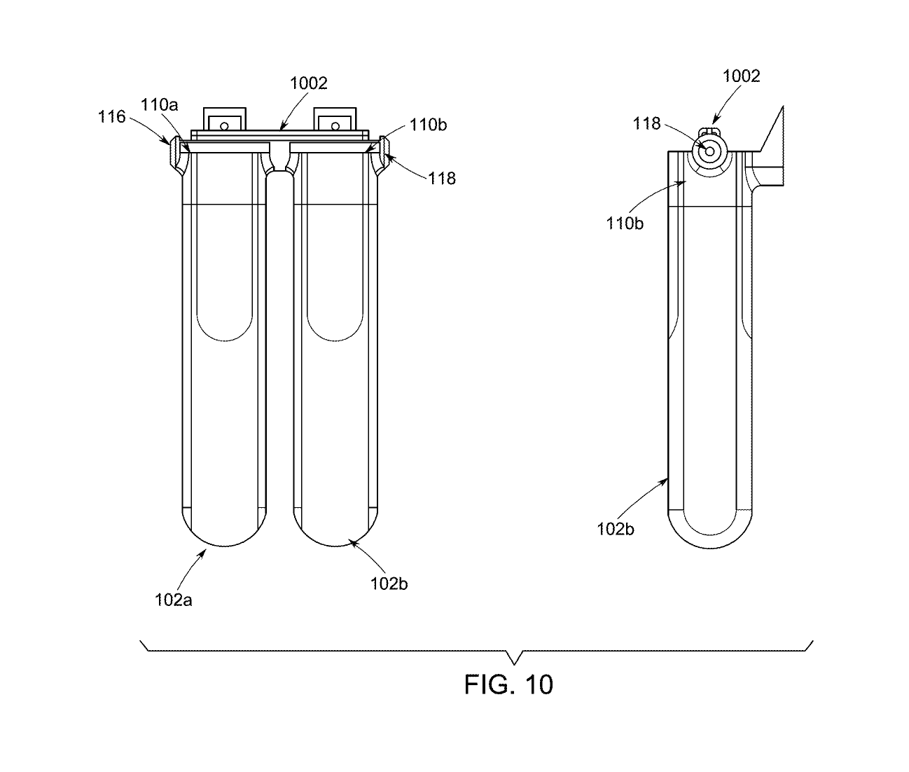

As illustrated in FIGS. 10-13, at least one embodiment of the invention can include a plenum attachment to implement a parallel flow manifold system.

FIG. 10 illustrates a dual manifold parallel flow system with a plenum attachment 1002, in accordance with a non-limiting example embodiment of the invention. Similar to the example depicted in FIG. 6, while FIG. 10 shows two manifolds 110a and 110b, at least one embodiment of the invention can include more than two manifolds incorporated into a parallel flow system via plenum attachment 1002. Also, FIG. 10 depicts filter canisters 102a and 102b, manifolds 110a and 110b, speed-fit caps 118 and 116, and plenum attachment 1002. These components are discussed further herein.

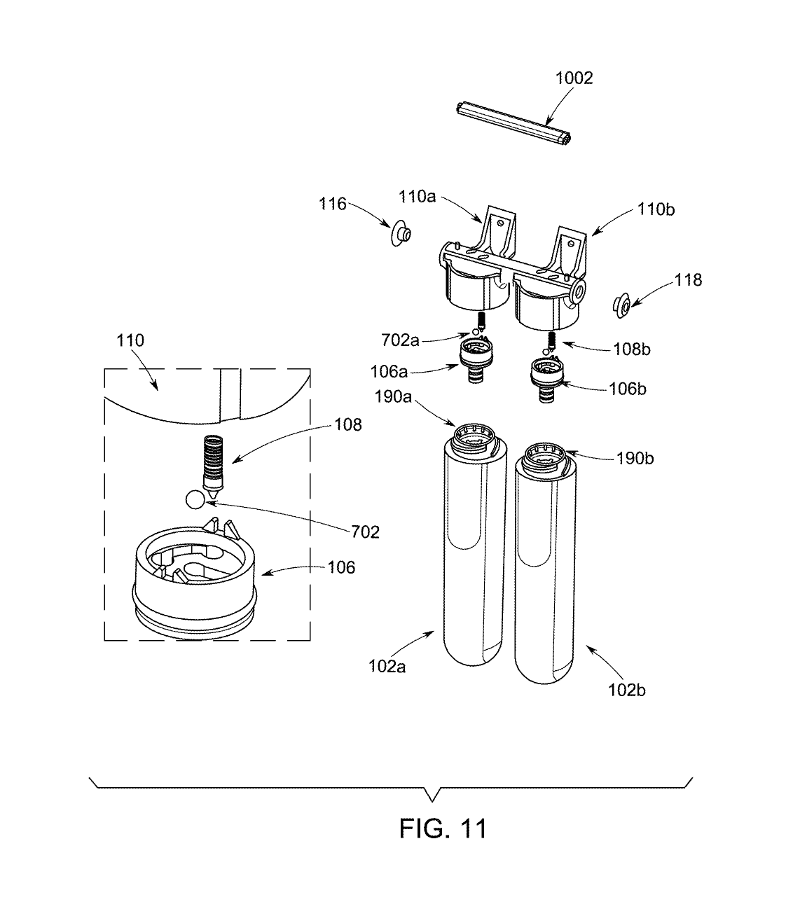

FIG. 11 illustrates an exploded view of a dual manifold parallel flow system with plenum attachment 1002, in accordance with a non-limiting example embodiment of the invention. By way of illustration, FIG. 11 depicts filter canisters 102a and 102b, annular canister/cartridge interlocking members 190a and 190b and bayonets 106a and 106b. As detailed herein (and illustrated in the close-up view of bayonet 106 in FIG. 11), in at least one embodiment of the invention, each bayonet 106 includes an inlet check valve 108 and an outlet check valve 702. The outlet check valve 702 can include an elastomeric ball valve.

FIG. 11 also depicts manifolds 110a and 110b, speed-fit caps 118 and 116, and plenum attachment 1002, which is fastened to a top horizontal surface spanning both manifold 110a and 110b.

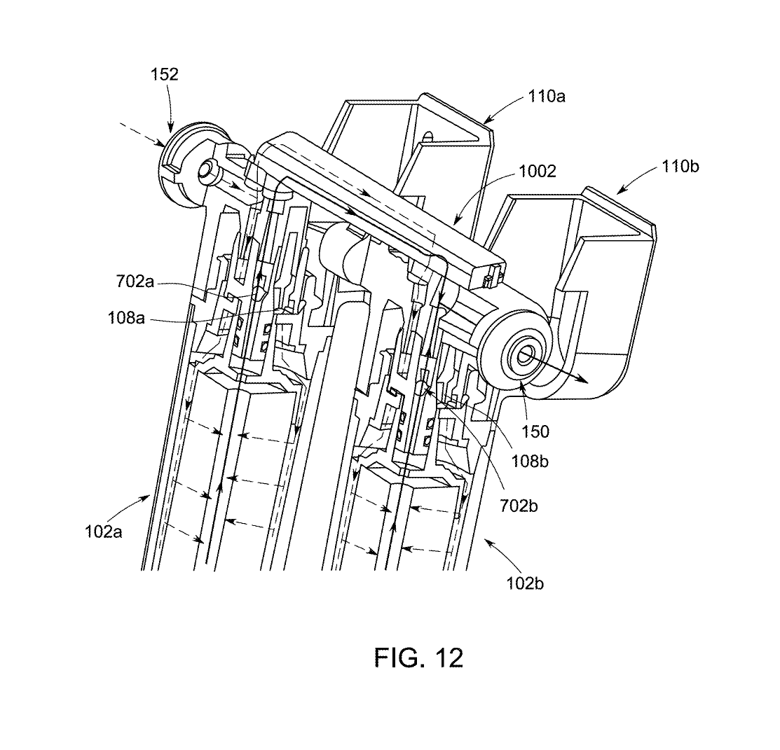

FIG. 12 illustrates a flow network in a parallel flow manifold system with plenum attachment 1002, in accordance with a non-limiting example embodiment of the invention. By way of illustration, FIG. 12 depicts filter canisters 102a and 102b and manifolds 110a and 110b. Specifically, a pre-filtered inlet stream of fluid (represented by the dashed line) enters manifold inlet port 152 and travels into and through the plenum attachment 1002 as well as into canister 102a through the inlet check valve 108a and through the filtration media. The portion of the pre-filtered inlet stream that traveled through the plenum attachment 1002 continues into canister 102b through the inlet check valve 108b and through the filtration media.

As additionally illustrated in FIG. 12, after the pre-filtered inlet stream flows through the filtration media, the filtered outlet stream (represented by the bold solid line) travels through outlet check valves 702a and 702b, respectively, and continues into and through the plenum attachment 1002 to ultimately exit through manifold outlet port 150.

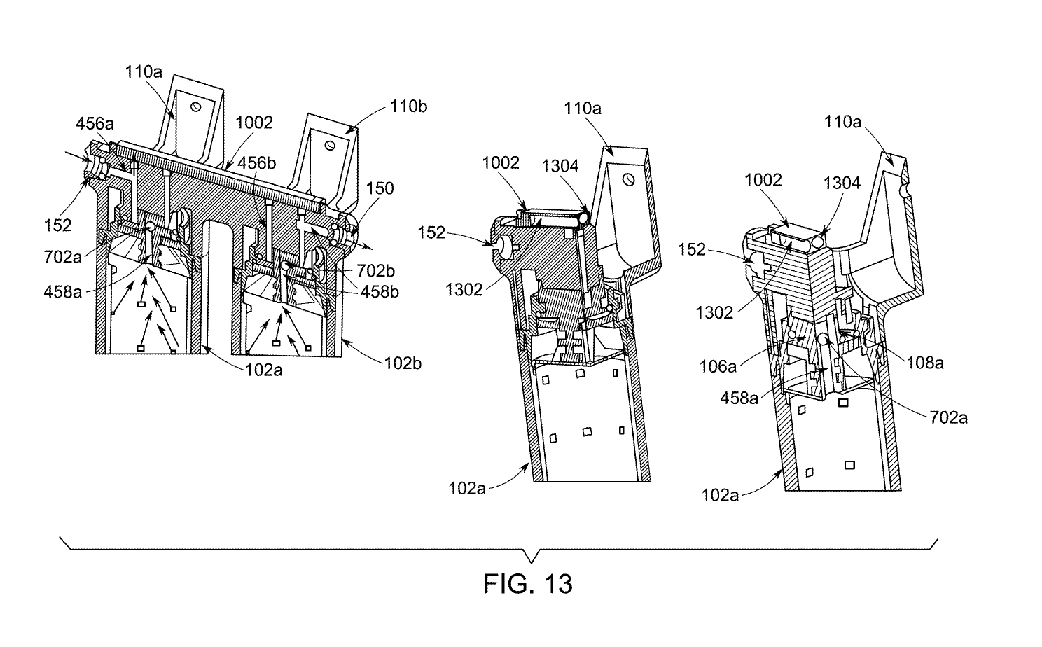

FIG. 13 illustrates cross-section views of a parallel flow manifold system with plenum attachment 1002, in accordance with a non-limiting example embodiment of the invention. By way of illustration, FIG. 13 depicts filter canisters 102a and 102b and manifolds 110a and 110b. Specifically, the cross-section views of FIG. 13 show a pre-filtered inlet stream of fluid entering manifold inlet port 152 and traveling into flow inlet channel 456a, a portion of the fluid moving up into/through influent channel 1302 of plenum attachment 1002 and a portion of the fluid moving into canister 102a around the inlet check valve 108a and into the filtration media via flow inlet channel 456a. The portions of fluid move into the separate components as a result of known principles such as the path of least resistance. After the portion of the pre-filtered inlet stream flows through the filtration media, a filtered outlet stream travels around outlet check valve 702a (which is positioned in bayonet 106a), and continues into/through flow outlet channel 458a and into and through secondary flow channel 1304 within plenum attachment 1002 to ultimately exit through manifold outlet port 150 via flow outlet channel 458b.

As similarly illustrated in FIG. 12, the portion of the pre-filtered inlet stream that traveled from inlet port 152 through influent channel 1302 of plenum attachment 1002 continues into flow inlet channel 456b of canister 102b, around inlet check valve 108b and through the filtration media. After this portion of the pre-filtered inlet stream flows through the filtration media, a filtered outlet stream travels around outlet check valve 702b (which is positioned in bayonet 106b (not numbered in FIG. 13)), and continues through flow outlet channel 458b, ultimately exiting through manifold outlet port 150.

Accordingly, in at least one embodiment of the invention, the influent, non-filtered water stream enters at one inlet 152 of the manifold 110, where it is distributed via a permanently attached dual flow plenum 1002. The influent water is directed to both the first and all subsequent filters in parallel via the influent channel 1302 of plenum arrangement 1002. Water is then directed into the filter canisters 102, where it is filtered and then returned to the secondary flow channel 1304 within the plenum attachment 1002, after which, all filtered waters are directed to a single outlet 150 of the manifold 110.

One advantage that may be realized in the practice of some embodiments of the described systems and techniques is providing the ability to obtain both higher extraction levels and higher system flow rates relative to in-series systems by adding filter canisters into the system for approximate simultaneous, parallel flow and filtration across the multiple canisters.

Accordingly, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A multiple manifold apparatus comprising:
two or more manifolds, wherein at least a first manifold comprises:
a flow inlet channel defined in the manifold from a manifold inlet port to an inlet check valve, and from the manifold inlet port to an inlet connecting line; and
a flow outlet channel defined in the manifold from an outlet check valve to an outlet connecting line;
wherein at least a second manifold comprises:
a flow inlet channel defined in the manifold from the inlet connecting line to an inlet check valve; and
a flow outlet channel defined in the manifold from an outlet check valve to a manifold outlet port, and from the outlet connecting line to the manifold outlet port;
wherein the inlet connecting line is fluidly coupled to the flow inlet channel defined in the first manifold and to the flow inlet channel defined in the second manifold, and the outlet connecting line is fluidly coupled to the flow outlet channel defined in the first manifold and to the flow outlet channel defined in the second manifold.

2. The apparatus of claim 1, wherein the outlet check valve is an elastomeric ball valve.

3. The apparatus of claim 1, further comprising fittings positioned in holes on each manifold, wherein one end of the inlet connecting line and one end of the outlet connecting line are each positioned into a fitting.

4. The apparatus of claim 1, wherein the multiple manifold apparatus creates a parallel flow arrangement for water filtration by multiple filter canisters.

5. The apparatus of claim 1, wherein the inlet connecting line and the outlet connecting line are tubes composed of polypropylene material.

6. The apparatus of claim 1, further comprising a cover positioned over the inlet connecting line and the outlet connecting line and coupled to the two or more manifolds.

7. A fluid filtration system comprising:
two or more manifolds, wherein at least a first manifold comprises:
a flow inlet channel defined in the manifold from a manifold inlet port to an inlet check valve, and from the manifold inlet port to an inlet connecting line; and
a flow outlet channel defined in the manifold from an outlet check valve to an outlet connecting line;
wherein at least a second manifold comprises:
a flow inlet channel defined in the manifold from the inlet connecting line to an inlet check valve; and
a flow outlet channel defined in the manifold from an outlet check valve to a manifold outlet port, and from the outlet connecting line to the manifold outlet port;
wherein the inlet connecting line is fluidly coupled to the flow inlet channel defined in the first manifold and to the flow inlet channel defined in the second manifold, and the outlet connecting line is fluidly coupled to the flow outlet channel defined in the first manifold and to the flow outlet channel defined in the second manifold; and
a filter cartridge having a filter media structure assembly and at least one channel for directing a flow of fluid.

8. The system of claim 7, wherein the outlet check valve is an elastomeric ball valve.

9. The system of claim 7, further comprising fittings positioned in holes on each manifold, wherein one end of the inlet connecting line and one end of the outlet connecting line are each positioned into a fitting.

10. The system of claim 7, wherein the multiple manifold apparatus creates a parallel flow arrangement for water filtration by multiple filter canisters.

11. The system of claim 7, wherein the inlet connecting line and the outlet connecting line are tubes composed of polypropylene material.

12. The system of claim 7, further comprising a cover positioned over the inlet connecting line and the outlet connecting line and coupled to the two or more manifolds.

13. A multiple manifold apparatus for water filtration comprising:
two or more manifolds, wherein at least a first manifold comprises:
a flow inlet channel defined in the manifold from a manifold inlet port to an inlet check valve, and from the manifold inlet port to an influent channel defined in a dual flow plenum; and
a flow outlet channel defined in the manifold from an outlet check valve to a secondary flow channel defined in the dual flow plenum;
wherein at least a second manifold comprises:
a flow inlet channel defined in the manifold from the influent channel to an inlet check valve; and
a flow outlet channel defined in the manifold from an outlet check valve to a manifold outlet port, and from the secondary flow channel to the manifold outlet port;
wherein the influent channel is fluidly coupled to the flow inlet channel defined in the first manifold and to the flow inlet channel defined in the second manifold, and the secondary flow channel is fluidly coupled to the flow outlet channel defined in the first manifold and to the flow outlet channel defined in the second manifold.

14. The apparatus of claim 13, wherein the outlet check valve is an elastomeric ball valve.

15. The apparatus of claim 13, wherein the multiple manifold apparatus creates a parallel flow arrangement for water filtration by multiple filter canisters.

16. The apparatus of claim 13, wherein the dual flow plenum is coupled to a portion of a surface of the multiple manifold apparatus.

17. A fluid filtration system comprising:
two or more manifolds, wherein at least a first manifold comprises:
a flow inlet channel defined in the manifold from a manifold inlet port to an inlet check valve, and from the manifold inlet port to an influent channel defined in a dual flow plenum; and
a flow outlet channel defined in the manifold from an outlet check valve to a secondary flow channel defined in the dual flow plenum;
wherein at least a second manifold comprises:
a flow inlet channel defined in the manifold from the influent channel to an inlet check valve; and
a flow outlet channel defined in the manifold from an outlet check valve to a manifold outlet port, and from the secondary flow channel to the manifold outlet port;
wherein the influent channel is fluidly coupled to the flow inlet channel defined in the first manifold and to the flow inlet channel defined in the second manifold, and the secondary flow channel is fluidly coupled to the flow outlet channel defined in the first manifold and to the flow outlet channel defined in the second manifold; and
a filter cartridge having a filter media structure assembly and at least one channel for directing a flow of fluid.

18. The system of claim 17, wherein the outlet check valve is an elastomeric ball valve.

19. The system of claim 17, wherein the multiple manifold apparatus creates a parallel flow arrangement for water filtration by multiple filter canisters.

20. The apparatus of claim 17, wherein the dual flow plenum is coupled to a portion of a surface of the multiple manifold apparatus.
